(19) United States
(12) Patent Application Publication
(10) Pub. No.: US 2025/0315917 A1
(43) Pub. Date: Oct. 9, 2025

(54) SYSTEMS AND METHODS FOR PANORAMIC AND TACTICAL VIDEO GENERATION

(71) Applicant: STATS LLC, Chicago, IL (US)

(72) Inventors: John WILDE, Sidcup (GB); Ondrej POKORNY, Velke Mezirici (CZ); Baris UNAL, Prague (CZ)

(73) Assignee: STATS LLC, Chicago, IL (US)

(21) Appl. No.: 19/172,258

(22) Filed: Apr. 7, 2025

Related U.S. Application Data
(60) Provisional application No. 63/631,684, filed on Apr. 9, 2024.

(51) Int. Cl. G06T 3/16; G06T 7/90; G06T 11/00

(52) U.S. Cl. CPC G06T 3/16; G06T 7/90; G06T 11/001; G06T 2207/10016; G06T 2207/10024; G06T 2207/30221

(57) ABSTRACT

A system may receive a plurality of sports event video feeds, whereupon, the system may calibrate the plurality of sports event video feeds. The system may generate a panoramic video feed, wherein the panoramic video feed is generated by stitching together the calibrated plurality of sports event video feeds. The system may obtain tracking data for at least one asset in the sports event and generate a tactical video feed, wherein generation of the tactical video feed is based on the tracking data. The system may further balance and calibrate color data across the plurality of sports event video feeds.

### CROSS-REFERENCE TO RELATED APPLICATION

This application claims priority to U.S. Provisional Application No. 63/631,684, filed Apr. 9, 2024, which is hereby incorporated by reference in its entirety.

### TECHNICAL FIELD

Various aspects of the present disclosure relate generally to machine learning for sports applications, and in particular, various aspects relate to computer vision and machine learning techniques for panoramic and/or tactical video generation based on tracking data and other desired parameters and/or inputs.

### INTRODUCTION

The generation of panoramic and tactical video feeds from multiple cameras in a sports event are particularly important for a consumer viewing experience, as well as for accurate collection of data throughout the duration of a sports event. These tasks are particularly important in computer-vision and machine learning applications where various factors may affect the accuracy of such data collection, including player occlusion, poor camera angles and video quality, and inaccurate color representation.

Unless otherwise indicated herein, the materials described in this section are not prior art to the claims in this application and are not admitted to be prior art, or suggestions of the prior art, by inclusion in this section.

### SUMMARY

In some aspects, the techniques described herein relate to a method for video generation in a sports event, the method including: receiving, via a computer, a plurality of sports event video feeds; calibrating, via the computer, the plurality of sports event video feeds; generating, via the computer, a panoramic video feed, wherein the panoramic video feed is generated by stitching together the calibrated plurality of sports event video feeds; obtaining, via the computer, tracking data for at least one asset in the sports event; and generating, via the computer, a tactical video feed, wherein generation of the tactical video feed is based on the tracking data and wherein the tactical video feed is a subset of the panoramic video feed selected based on one or more video parameters.

In some aspects, the techniques described herein relate to a method, wherein the tracking data includes tracking data for at least one player in the sports event.

In some aspects, the techniques described herein relate to a method, wherein calibrating the plurality of sports event video feeds further includes: identifying, via the computer, common points between the plurality of sports event video feeds; and calculating, via the computer, a camera homography between each of the plurality of sports events feeds, wherein the camera homography is based on the identified common points.

In some aspects, the techniques described herein relate to a method, wherein the tactical video feed is dynamically updated, via the computer, based on updates to the tracking data.

In some aspects, the techniques described herein relate to a method, wherein generating a panoramic video feed further includes: obtaining, via the computer, color data for each of the calibrated plurality of sports event video feeds; calculating, via the computer, a color balancing solution based on the color data for each of the calibrated plurality of sports event video feeds; and applying, via the computer, a color calibration to the panoramic video feed, wherein the color calibration is based on the color balancing solution.

In some aspects, the techniques described herein relate to a method, wherein the color data is obtained, via the computer, prior to the start of the sports event.

In some aspects, the techniques described herein relate to a method, wherein calculating a color balancing solution further includes: extracting, via the computer, at least one prominent color from at least one of the calibrated plurality of sports event video feeds; matching, via the computer, the at least one prominent color to at least one prominent color from a different calibrated sports event video feed to generate at least one matched color pair; and incorporating, via the computer, the at least one matched color pair into the color data.

In some aspects, the techniques described herein relate to a system for video generation in a sports event, the system including: a non-transitory computer readable medium configured to store processor-readable instructions; and a processor operatively connected to the non-transitory computer readable medium, and configured to execute the instructions to perform operations including: receiving a plurality of sports event video feeds; calibrating the plurality of sports event video feeds; generating a panoramic video feed, wherein the panoramic video feed is generated by stitching together the calibrated plurality of sports event video feeds; obtaining tracking data for at least one asset in the sports event; and generating a tactical video feed, wherein generation of the tactical video feed is based on the tracking data and wherein the tactical video feed is a subset of the panoramic video feed selected based on one or more video parameters.

In some aspects, the techniques described herein relate to a system, wherein the tracking data includes tracking data for at least one player in the sports event.

In some aspects, the techniques described herein relate to a system, wherein calibrating the plurality of sports event video feeds further includes: identifying common points between the plurality of sports event video feeds; and calculating a camera homography between each of the plurality of sports events feeds, wherein the camera homography is based on the identified common points.

In some aspects, the techniques described herein relate to a system, wherein the tactical video feed is dynamically updated, via the computer, based on updates to the tracking data.

In some aspects, the techniques described herein relate to a system, wherein generating a panoramic video feed further includes: obtaining color data for each of the calibrated plurality of sports event video feeds; calculating a color balancing solution based on the color data for each of the calibrated plurality of sports event video feeds; and applying a color calibration to the panoramic video feed, wherein the color calibration is based on the color balancing solution.

In some aspects, the techniques described herein relate to a system, wherein the color data is obtained, via the computer, prior to the start of the sports event.

In some aspects, the techniques described herein relate to a system, wherein calculating a color balancing solution further includes: extracting at least one prominent color from at least one of the calibrated plurality of sports event video feeds; matching the at least one prominent color to at least one prominent color from a different calibrated sports event video feed to generate at least one matched color pair; and incorporating the at least one matched color pair into the color data.

In some aspects, the techniques described herein relate to a non-transitory computer readable medium configured to store processor-readable instructions, wherein when executed by a processor, the instructions perform operations including: receiving a plurality of sports event video feeds; calibrating the plurality of sports event video feeds; generating a panoramic video feed, wherein the panoramic video feed is generated by stitching together the calibrated plurality of sports event video feeds; obtaining tracking data for at least one asset in the sports event; and generating a tactical video feed, wherein generation of the tactical video feed is based on the tracking data and wherein the tactical video feed is a subset of the panoramic video feed selected based on one or more video parameters.

In some aspects, the techniques described herein relate to a non-transitory computer readable medium, wherein the tracking data includes tracking data for at least one player in the sports event.

In some aspects, the techniques described herein relate to a non-transitory computer readable medium, wherein calibrating the plurality of sports event video feeds further includes: identifying common points between the plurality of sports event video feeds; and calculating a camera homography between each of the plurality of sports events feeds, wherein the camera homography is based on the identified common points.

In some aspects, the techniques described herein relate to a non-transitory computer readable medium, wherein the tactical video feed is dynamically updated, via the computer, based on updates to the tracking data.

In some aspects, the techniques described herein relate to a non-transitory computer readable medium, wherein generating a panoramic video feed further includes: obtaining color data for each of the calibrated plurality of sports event video feeds; calculating a color balancing solution based on the color data for each of the calibrated plurality of sports event video feeds; and applying a color calibration to the panoramic video feed, wherein the color calibration is based on the color balancing solution.

In some aspects, the techniques described herein relate to a non-transitory computer readable medium, wherein calculating a color balancing solution further includes: extracting at least one prominent color from at least one of the calibrated plurality of sports event video feeds; matching the at least one prominent color to at least one prominent color from a different calibrated sports event video feed to generate at least one matched color pair; and incorporating the at least one matched color pair into the color data.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A is a block diagram of an exemplary tracking and analytics environment, according to example embodiments.

FIG. 1B is another block diagram of an exemplary tracking, analytics, and video generation environment, according to example embodiments.

FIG. 1C is another block diagram of an exemplary tracking, analytics, and video generation environment, according to example embodiments.

FIG. 2 depicts an exemplary flow diagram for generating panoramic video and tactical video, according to example embodiments.

FIG. 3 depicts an exemplary flow diagram for generating panoramic video and tactical video and balancing and calibrating color, according to example embodiments.

FIG. 4 illustrates an exemplary image for generating tactical videos, according to example embodiments.

FIG. 5A illustrates an exemplary image of a plurality of video feeds, according to example embodiments.

FIG. 5B illustrates an exemplary image of a generated panoramic video feed, according to example embodiments.

FIG. 6 illustrates an exemplary image of a generated tactical video, according to example embodiments.

FIG. 7 illustrates an exemplary image of a panoramic video prior to color balancing and calibration, according to example embodiments.

FIG. 8A illustrates an exemplary representation of cropped/extracted video feed frames for color balancing, according to example embodiments.

FIG. 8B illustrates an exemplary representation for color balancing, according to example embodiments.

FIG. 9 illustrates exemplary representations of cropping/extraction of a playing field from a video frame, according to example embodiments.

FIG. 10 illustrates exemplary images of a plurality of video feeds, according to example embodiments.

FIG. 11 depicts a flow diagram of a method for video generation in a sports event, according to example embodiments.

FIG. 12 depicts a flow diagram for training a machine learning model, according to example embodiments.

FIG. 13A is a block diagram illustrating an architecture of a computing system, according to example embodiments.

FIG. 13B is a block diagram illustrating a computing system, according to example embodiments.

To facilitate understanding, identical reference numerals have been used, where possible, to designate identical elements that are common to the figures. It is contemplated that elements disclosed in one embodiment may be beneficially utilized in other embodiments without specific recitation.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Various aspects of the present disclosure relate generally to techniques for machine learning for sports applications. For instance, certain aspects include the stitching, calibration, and processing of multiple video feeds from multiple cameras to generate a panoramic video and the processing of tracking data, defined attributes or criteria, and/or other inputs to generate a dynamic tactical video. Similarly, certain aspects include color calibration of the multiple video feeds and/or of the generated panoramic video or tactical video.

Technical advantages of the disclosed techniques include generating high resolution panoramic and/or tactical video generation from multiple, separately mounted cameras. By using the techniques disclosed herein, such generated video feeds may be generated in a more efficient, accurate, and faster manner while utilizing less computational resources.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples herein are illustrative only. The techniques and technologies of this disclosure may be adapted to any suitable activity.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may be automatically correlated with a loss indicator for an opposing team. As another example, a score statistic may be considered a positive attribution for a scoring team and a negative attribution for a team being scored upon. As another example, a given score may be ranked against one or more scores based on a relative position of the score in comparison to the one or more other scores.

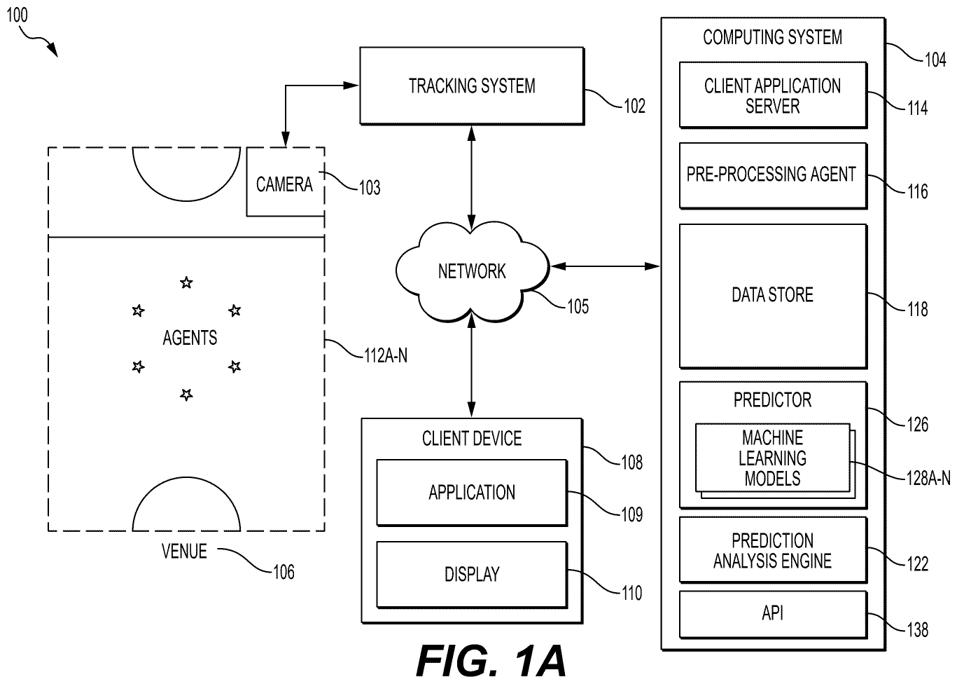

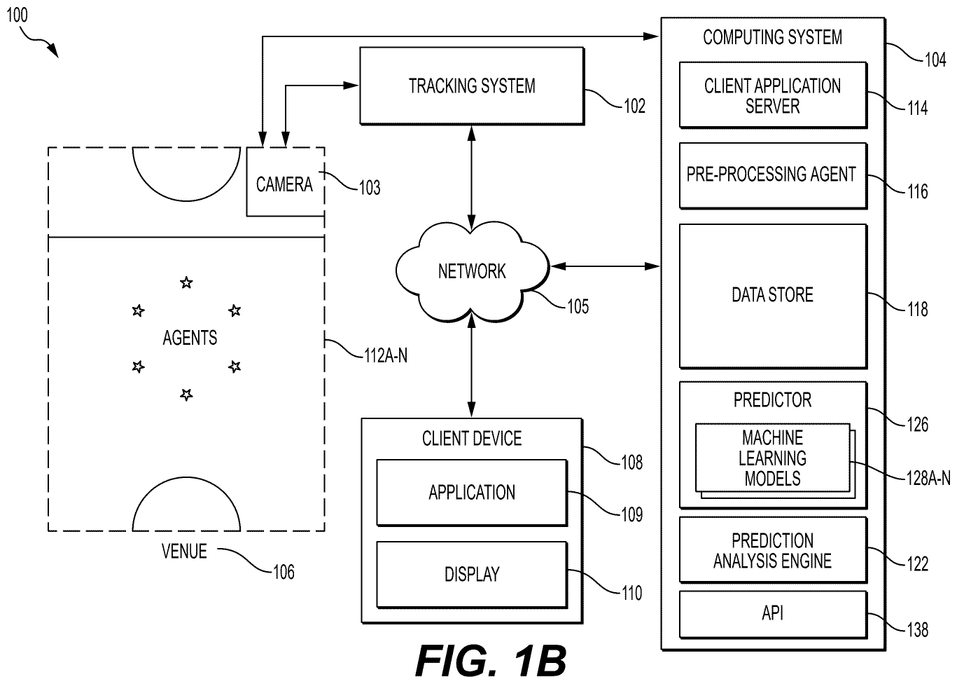

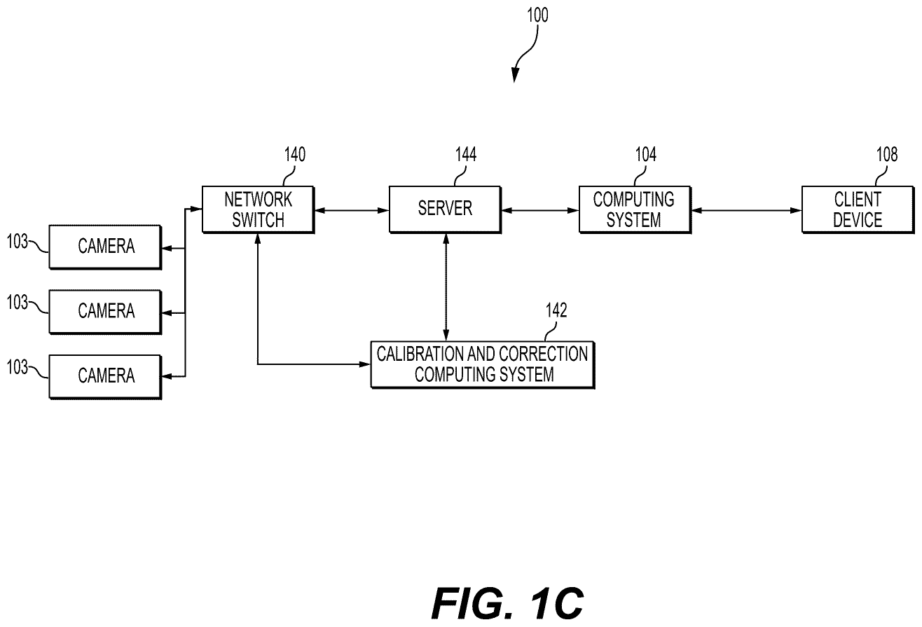

A sports machine learning model may be trained based on sports tracking and/or event data, as discussed herein. Such data may include player and/or object position information, movement information, trends, and/or changes. For example, as further discussed herein in reference to FIG. 1A, a sports machine learning model may be trained by modifying one or more weights, layers, nodes, biases, and/or synapses to associate given positions in reference to the playing surface of venue 106 and/or in reference to one or more agents 112A-N. As another example, a sports machine learning model may be trained by modifying one or more weights, layers, nodes, biases, and/or synapses to associate given movement or trends in reference to the playing surface of venue 106 and/or in reference to one or more agents 112A-N. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in viewing sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.), playing surface boundaries and landmarks, player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

While soccer and various aspects relating to soccer (e.g., positions and tracks of players on a pitch, sports-specific or league-specific broadcast parameters, etc.) are described in the present aspects as illustrative examples, the present aspects are not limited to such examples. For example, the present aspects can be implemented for other sports or activities, such as American football, basketball, baseball, tennis, gold, cricket, rugby, team sports, individual sports, and so forth.

Systems and techniques disclosed herein are directed to panoramic video generation and subsequent tactical video generation from multiple, separately mounted cameras. According to one embodiment, the term “panoramic” video may refer to a wide video view that covers a full playing field and much of the surrounding environment (e.g., stadium) at a high resolution. Similarly, the term “tactical” video may refer to a moving, dynamically-zoomed area of a panoramic video. The zoomed and cropped area of the panoramic video may be selected according to various attributes or inputs, including player tracking data, ball tracking data, league- or sports-specific viewing standards, or other similar criteria. For example, tactical video may be utilized to display a specific subset of on-field players where, for example, in a soccer application, a tactical video may be automatically updated to show a video feed containing all out-field players as well as one goalkeeper.

Some approaches for panoramic and tactical video generation utilize a single high-definition camera, yet the resulting wide video view may be unable to provide and capture a sufficiently high-definition picture while maintaining high-resolution and quality. This is particularly true where the panoramic view may be utilized for computer vision, machine learning, or other applications, including generation and processing of tracking data. As a result, tactical video generation may be impossible or may be of such poor quality to be unusable for computer vision, machine learning, or other applications. Similarly, such approaches for panoramic video and tactical video generation are relatively inefficient in their usage of processing and camera resources, which may be a particularly acute problem where the solution is to be deployed in-venue where equipment space may be limited.

Additionally, some approaches are limited to utilization of panoramic and tactical video feeds from broadcast partners, where such feeds are limited exclusively to the specific camera view received from the broadcast partners. Such an approach limits the available viewpoints, hindering the ability to view, track, and/or collect data on players or other assets that are not visible in the broadcast video feed. Similarly, such broadcast video feeds may suffer from low video quality, unbalanced colorimetery, or other shortcomings that detract from the ability to apply accurate and efficient computer vision, machine learning, or other techniques to the video feed.

According to systems and techniques disclosed herein, automatically stitching together multiple video feeds from multiple cameras overcomes various factors such as low video quality, inaccurate tracking data, inaccurate and imprecise tactical video generation, and/or color disparity across camera and video feeds. Similarly, in comparison to processing- and resource-heavy applications, the systems and techniques disclosed herein provide a lightweight, optimized solution such that the video capture, computing, and/or processing may be performed in-venue due to the small size of a deployment solution.

According to techniques and systems disclosed herein, in comparison to utilizing broadcast video feeds or using a single-camera solution, the present methods may utilize in-venue live tracking data to generate the output tactical video, where players can be accurately and precisely identified on the playing field, permitting the tactical video generation to capture, for example, active players on the sports field (e.g., displaying players engaged with the ball, cropping and following specific players, cropping and following specific teams, or generating tactical video based on other defined criteria) without inaccurately omitting players from the tactical video feed. Similarly, the in-venue tracking data may be utilized with color balancing techniques to refine and tune the color uniformity across individual camera and/or video feeds, permitting the techniques and systems to be compatible with cameras of different specifications and quality, while continuing to deliver a panoramic and tactical video output of uniform color and quality.

According to systems and techniques disclosed herein, a geometric-stitching operation may be performed in which an automated system and/or a human operator may perform an initial camera/video feed calibration process to identify common points (e.g., spatial points) in camera overlap areas, including any landmark points in a playing field (e.g., sidelines, penalty boxes, yard lines, hash marks, goal boxes, end zones, etc.). This calibration process may further include additional settings, including approximate in-venue camera mounting positions and distortion characteristics of particular camera lenses. The calibration steps permit a camera homography to be calculated between each image view (e.g., frame view) and the real-world field position (e.g., field view). By mapping between field and frame and vice versa, the system can transform multiple camera views into a single common view (e.g., selecting the center camera frame view). For example, the single common view may generate a video feed view representing a formation as if all cameras were mounted at the same in-venue position and aimed in the same direction. By applying this homographic transform to every video frame, the system can thus generate a panoramic video with high resolution, a wide field of view (e.g., the full playing field), and high quality. This operation is optimized to allow parallelization on graphical processors for real-time application utilizing efficient resource management (e.g., on lightweight small form factor GPU's and edge devices).

The systems and techniques disclosed herein further address visual corrections, including unbalanced and irregular colors in a video feed as well as different lighting conditions, particularly where individual cameras are positioned to capture different angles of a sports event and are thus located at different locations in a venue. As discussed herein, a color balancing solution is applied to the multiple video feeds, wherein the system continuously and/or periodically generates color statistics from video frames of each camera and calculate levels of key color metrics. These color statistics may then be averaged and normalized across each of the cameras to impart color and texture uniformity. For example, this color balancing process computes statistics of each camera, such as the mean color and/or deviation of individual colors in an RGB color space. These individual image colors may then be transferred from the color of average of all images. Further, the present method may compute this average by utilizing colors only from the sports field (e.g., the surrounding area is excluded) and only if players of all teams are present in a specific camera view. This approach permits a high quality video and data output and allows for more accurate processing of extreme cases.

According to systems and techniques disclosed herein, tactical video feeds may be generated based on existing tracking data, live tracking data, and/or real-time tracking data generated from a panoramic video feed. This tracking data may be utilized to create a zoomed and/or cropped “cut-out” of the panoramic video, generated according to particular video parameters for capturing the area of interest. For example, tactical video may be generated so as to capture all players within a certain vicinity of the ball. Each video frame of this tactical view is calculated, whereupon one or more filters may be applied to both the position and size of the “cut-out” tactical video frame to naturally smooth the motion in the panning and/or zooming of the tactical view. Movement of the tactical view may also be guided by the detection and filtering of ball tracking. For example, by tracking the ball and its movement, a more accurate prediction of player movements can be generated, thus further improving the tactical viewing experience.

According to systems and techniques disclosed herein, the stitching and calibration operations applied to separate camera feeds in the course of generating panoramic video and tactical video may be further utilized to synchronize the internal rates of the individual camera clocks by locking on to certain timestamps and restarting the camera streams via the system environment software. For example, certain camera clocks of different makes, models, ages, etc. may utilize different clock speeds, where such clock speeds may be synchronized with the system environment software during the process of calibrating and stitching multiple camera feeds into a single, unified panoramic video feed.

FIG. 1A is a block diagram illustrating a tracking and analytics environment 100, according to example aspects. Environment 100 includes tracking system 102, computing system 104, and client device 108 connected via network 105. In the example depicted, tracking system 102 obtains various measurements of game play, and transmits the measurements across network 105 to computing system 104, where the measurements can be used in conjunction with one or more machine learning models. In an example, environment 100 and its components combine multiple camera and/or video feeds to generate a single panoramic video. The environment 100 and its components further utilize tracking data to generate tactical video from the panoramic video, wherein the tactical video includes a cropped and/or zoomed view of the panoramic video that is generated based on specific tracking attributes, criteria, and/or other inputs. Additionally, environment 100 and its components calibrate camera and/or video feeds and the resulting panoramic video and tactical video feeds to balance and correct colorimetry imbalances due to camera differences, variable lighting conditions, poor video quality, and other detractors.

Tracking system 102 may be positioned in, adjacent to, or near a venue 106, or additionally or alternatively, tracking system 102 may access a video feed via network 105, wherein network 105 may connect tracking system 102 to one or more cameras 103 or to one or more video feeds. Non-limiting examples of venue 106 include stadiums, fields, pitches, and courts. Venue 106 includes agents 112A-N (players). Tracking system 102 may be configured to record the motions and actions of agents 112A-N on the playing surface, as well as one or more other objects of relevance (e.g., ball, referees, etc.).

In some aspects, tracking system 102 may be an optically-based system using, for example, multiple cameras 103. For example, three stationary cameras may be utilized for generating panoramic video and tactical video feeds. Similarly, for example, a system of six stationary, calibrated cameras, which project the three-dimensional locations of players and the ball onto a two-dimensional overhead view of the field/court may be used to provide exemplary tracking data and/or for generating panoramic and tactical video feeds.

In another example, a mix of stationary and non-stationary cameras may be used to capture video of a playing field during a sports event, as well as to capture motions of all agents 112A-N on the playing surface and/or one or more objects of relevance. Utilization of such tracking system (e.g., tracking system 102) may result in many different camera views of the playing field (e.g., high sideline view, free-throw line view, huddle view, face-off view, end zone view, etc.). In some aspects, tracking system 102 may be used for a video feed of a given match. In such aspects, each frame of the video feed may be stored in a game file.

In some embodiments, the tracking system 102 may provide a video feed, via network 105, to one or more machine learning models of computing system 104, to generate tracking data. The one or more machine learning models may identify players and/or objects in the video feed and convert them to digital representations. The digital representations of the players and/or objects and their respective positions may be tracked to identify tracking data such as movement data (e.g., changes in the positions), changes in movement, trends, etc. Such information may be used by a prediction module (e.g., predictor 126 or prediction analysis engine 122) to make predictions. The tracking data may be analyzed by the machine learning models to determine correlations between the tracking data and event types (e.g., goal scored, pass made, play types, etc.). For example, tracking data may be used to determine when a digital representation of an object (e.g., a ball) crosses a scoring object (e.g., a goal post). Based on such determination, an event type of a goal scored may be identified. Further, the digital representation of the player(s) that contacted the object (e.g., ball) prior to the goal scored event may be identified as the player(s) that contributed to or otherwise caused the event (e.g., goal). Accordingly, video feeds may be used to generate tracking data which may further be used to determine event data corresponding to certain sports events.

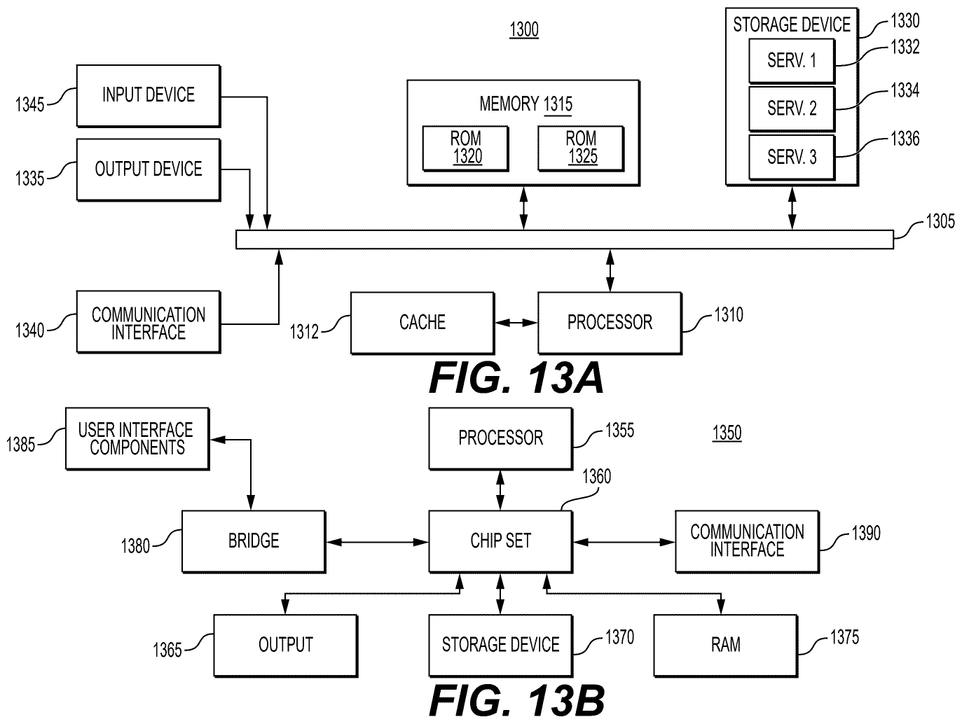

As explained above, tracking system 102 may be configured to communicate with computing system 104 via network 105. Computing system 104 may be configured to manage and analyze the data captured by tracking system 102. Computing system 104 may include a web client application server 114, a pre-processing agent 116, a data store 118, and a third-party Application Programming Interface (API) 138. An example of computing system 104 is depicted with respect to FIGS. 13A and 13B.

Pre-processing agent 116 may be configured to process data retrieved from data store 118 or tracking system 102 prior to input to predictor 126.

Data store 118 may be configured to store different kinds of data. In an example, data store 118 can store raw tracking data received from tracking system 102. The data store 118 can include historical game data, color data, camera data, live data, features, team data, player data, and/or prediction data. The historical game data can include historical team and player data for one or more sporting events. Live data can include data received from tracking system 102, e.g., in real time.

The feature vectors can be generated for a specific sporting event (e.g., a soccer match) or a combination of events. Feature vectors can include player and/or team features.

Predictor 126 includes one or more machine-learning models 128A-N. For example, predictor 126 may utilize tracking data (e.g., live tracking data from tracking system 102 and/or tracking data stored in data store 118) to identify areas of a panoramic video and/or areas of multiple video feeds to generate a tactical video, wherein the tactical video captures a portion of the field according to tracking data criteria or other inputs. Further, machine learning models 128A-N may be trained utilizing tracking data, prior game data, or other historical data to permit predictor 126, for example, to accurately identify and predict the movement of players, whereupon tactical video generation accurately and efficiently zooms, crops, and/or moves with the progression of players across a field, resulting in a smooth video appearance. Such methods may further allow generation of tactical video directly from camera/video feeds as opposed to directly from panoramic video where, for example, tactical video is generated based upon tracking data from the individual camera/video feeds. In such an embodiment, panoramic video generation may thus be omitted, conserving processing power and allowing for a more efficient method of generating tactical video.

Client device 108 may be in communication with computing system 104 via network 105. Client device 108 may be operated by a user. For example, client device 108 may be a mobile device, a tablet, a desktop computer, or any computing system having the capabilities described herein. Users may include, but are not limited to, individuals such as, for example, operators, subscribers, clients, prospective clients, or customers of an entity associated with computing system 104, such as individuals who have obtained, will obtain, or may obtain a product, service, or consultation from an entity associated with computing system 104.

Client device 108 may include one more applications 109. Application 109 may be representative of a web browser that allows access to a website or a stand-alone application. Client device 108 may access application 109 to access one or more functionalities of computing system 104. Client device 108 may communicate over network 105 to request a webpage, for example, from web client application server 114 of computing system 104. For example, client device 108 may be configured to execute application 109 to access content managed by web client application server 114. The content that is displayed to client device 108 may be transmitted from web client application server 114 to client device 108, and subsequently processed by application 109 for display through a graphical user interface (GUI) of client device 108.

Client device may include display 110. Examples of display 110 include, but are not limited to, computer displays, Light Emitting Diode (LED) displays, and so forth. Output or visualizations generated by application 109 can be displayed on display 110.

Functionality of sub-components illustrated within computing system 104 can be implemented in hardware, software, or some combination thereof. For example, software components may be collections of code or instructions stored on a media such as a non-transitory computer-readable medium (e.g., memory of computing system 104) that represent a series of machine instructions (e.g., program code) that implements one or more method operations. Such machine instructions may be the actual computer code the processor of computing system 104 interprets to implement the instructions or, alternatively, may be a higher level of coding of the instructions that is interpreted to obtain the actual computer code. The one or more software modules may also include one or more hardware components. Examples of components include processors, controllers, signal processors, neural network processors, and so forth.

Network 105 may be of any suitable type, including individual connections via the Internet, such as cellular or Wi-Fi networks. In some aspects, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some aspects, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

FIG. 1B depicts an exemplary embodiment of system environment 100, in which cameras 103 may be connected directly to computing system 104. According to this embodiment, for example, computing system 104 may utilized to create panoramic video directly from the video feed received from cameras 103. Following panoramic video generation, computing system 104 may subsequently utilize tracking data from tracking system 102, tracking data from data store 118, or other alternative criteria/attributes to generate tactical video, wherein the tactical video displays a cropped and/or zoomed subset of the panoramic video that satisfies, for example, the tracking data criteria or other attribute for a specific tactical video feed.

FIG. 1C depicts an exemplary embodiment of system environment 100 that is a lightweight, efficient solution that may be deployed in-venue. According to this embodiment, three separate cameras 103 are connected to a network switch 140 (or similar multi-point connection device), wherein the network switch 140 is directly connected to a server 144 and a calibration and correction computing system 142. Although three cameras 103 are provided herein as an example, it will be understood that any number of multiple cameras may be used to implement the techniques disclosed herein. The calibration and correction computing system 142 may receive panoramic video, sub sampled video, and or low-resolution video and may apply camera calibration, algorithm settings, and or filtering to the video to the server 144, wherein transform parameters, image filtering parameters, high-definition/high-resolution video, and/or tracking data may be provided to computing system 104 for further processing of the video feed(s). Calibration and correction computing system 142 may apply calibration and correction methods to video feeds prior to the start of a sports event and/or continuously or periodically throughout the duration of a sports event.

Computing system 104 may generate panoramic video and tactical video as disclosed elsewhere herein, wherein the panoramic video and/or tactical video may be delivered to at least one client device 108.

It will be appreciated by one of ordinary skill that certain components may be located external to the venue where, for example, the computing system 104 and/or client device 108 may be connected via a network 105 (e.g., via a server 144) for accessing and/or generating the panoramic and tactical video feeds.

The present embodiments benefit from a lightweight, easily deployable solution for in-venue deployment or for a hybrid in-venue/external deployment, where certain components are deployed outside the venue 106 and may be cloud-based or otherwise accessible via a network. For example, the computing system 104, client device 108, and/or tracking system 102 may be located outside the venue 106, where such components may be cloud-based applications and/or may otherwise be accessible via a network. Further, the panoramic and tactical video generation may be performed, for example, on a physically small system box (e.g., 20 cm×20 cm×20 cm) and/or single board computer due to the level of optimization in a parallel computing solution. Similarly, the delivery technique allows an automatic assessment of venue internet connections where, depending on available network bandwidth, the encoder generating the output data stream is dynamically tuned to cater for supporting a range of available bandwidths.

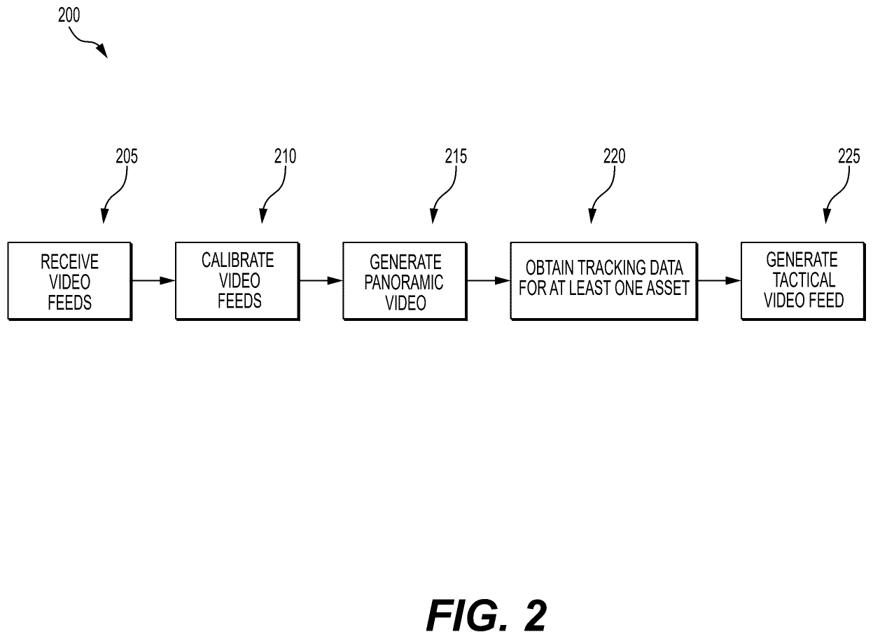

Referring now to FIG. 2, an exemplary flow diagram 200 is shown for generating panoramic video and tactical video, according to example embodiments. As shown in flow diagram 200 of FIG. 2, at step 205 multiple video feeds may be received from cameras 103 located at or within venue 106, and additionally or alternatively, the video feeds may be received from a broadcast feed that is accessed, for example, via a network 105, a local data store, or similar communications means. The video feed may include additional data and/or additional associated data types, including tracking data from tracking system 102 or other data received from the video feed or resulting from preprocessing of the video feed.

At step 210, an automated system and/or a human operator may perform an initial camera/video feed calibration process to identify common points (e.g., spatial points) in camera overlap areas, including any landmark points in a playing field (e.g., sidelines, penalty boxes, yard lines, etc.). For example, computer vision methods may be used to locate playing field landmarks within a video feed and match the landmarks among the different cameras. This calibration process may further include additional settings, including approximate in-venue camera mounting positions and distortion characteristics of particular camera lenses. The calibration steps permit a camera homography to be calculated between each image view (e.g., frame view) and the real-world field position (e.g., field view).

For example, a machine learning model may identify common points on a playing field and normalize those points onto the playing field across multiple cameras. These common points are subsequently correlated to the multiple cameras via the homographic transform process to generate harmonized common points for each camera feed based on the playing field.

Similarly, for example, a machine learning model may be trained based on one or more known landmark points in a playing field (e.g., sidelines, penalty boxes, yard lines, etc.) and/or in a specific venue, wherein the training may be based on historical video feeds (including, e.g., accompanying data) and/or simulated training data of the playing field and/or specific venue. These known landmark points may be provided to a training component of the machine learning model to generate a trained machine learning model, wherein the machine learning model may be provided comparison results that compare a trained output of the machine learning model against live video feeds from multiple camera feeds to generate harmonized common points for each camera feed.

At step 215, a geometric-stitching operation may be performed to generate a panoramic video feed. By mapping between the field and frame and vice versa, the system can transform multiple camera views into a single common view (e.g., selecting the center camera frame view). The single common view may be based on the identification and/or mapping of the common points discussed in reference to step 210. For example, the single common view may generate a video feed view representing a formation as if all cameras were mounted at the same in-venue position and aimed in the same direction. By applying this homographic transform to every video frame, the system can thus generate a panoramic video with high resolution, a wide field of view (e.g., the full playing field), and high quality. This operation is optimized to allow parallelization on graphical processors for real-time application utilizing efficient resource management (e.g., on lightweight small form factors GPU's and edge devices).

For example, each camera may have one homography feature that transforms every image pixel to the same plane to create the final image. For example, the target plane can be arbitrary (e.g., ground field plane or any other plane an operator may choose) or the plane of a different camera. The side camera image may be transformed into the image of a central camera in a 3-camera system. As one example, in a 4-camera system, the operator or an automated system may select any other camera image plane as a target.

It will be appreciated by one of ordinary skill that calibration may occur prior to the start of a sports event and/or may occur continuously or periodically throughout the duration of a sports event. Similarly, calibration may be performed at multiple points in the method of generating panoramic video and of generating tactical video.

At step 220, tracking data for at least one asset is obtained where such tracking data may include a variety of criteria or attributes for tactical video creation. For example, such tracking data may include player tracking, ball tracking, player role, or other pre-defined and/or real-time criteria or attributes for a variety of assets, including players, balls, teams, player roles, referees/officials, or other agents or implements of a sport. Such tracking data may be obtained in accordance with the techniques disclosed herein including those in reference to tracking system 102. For example, the tracking data may be obtained via a tracking data machine learning model trained to generate tracking data based on a training data set. The training data set may include, for example, a historical or simulated video feed and historical or simulated tagged tracking data. It will be appreciated by one of ordinary skill that step 220 may be performed prior to, concurrent with, or following the generation of panoramic video in step 215.

For example, FIFA soccer matches may have specific criteria for tactical video displays, including displaying at least 20 players on a field; when attacking progressed beyond the half line, the tactical video feed should include the defending goal-keeper and goal frame; and during set pieces, the tactical video feed should display the defending goal keeper. Similarly, a customer or consumer may desire to continuously view a specific player or player position, or the customer or consumer may desire to continuously view a certain defined area around the ball (e.g., a 10-yard radius around a ball), where tactical video feed is generated according to these parameters. The tactical video feed may identify players, objects, and/or the like in accordance with such parameters and may be a subset of a panoramic video feed selected to comply with such parameters. A system component may automatically and continuously identify a portion of a panoramic video feed to provide the tactical video feed from the overall video feed, such that the tactical video feed complies with such parameters.

At step 225, tactical video feeds are generated, wherein the tactical video may include a subset (e.g., zoomed-in and/or cropped “cut-out”) of the panoramic video, generated according to particular parameters for capturing the area of interest. Tactical video feeds may be generated based on existing tracking data, live tracking data, and/or real-time tracking data generated from a panoramic video feed. For example, tactical video may be generated so as to capture all players within a certain vicinity of a ball, puck, etc. Each video frame of this view is calculated, whereupon one or more filters may be applied to both the position and size of the “cut-out” tactical video frame to naturally smooth the motion in the panning and/or zooming of the tactical view. Movement of the tactical video may also be guided by the detection and filtering of ball tracking. For example, by tracking the ball, a more accurate prediction of player movements can be generated, thus further improving the tactical viewing experience.

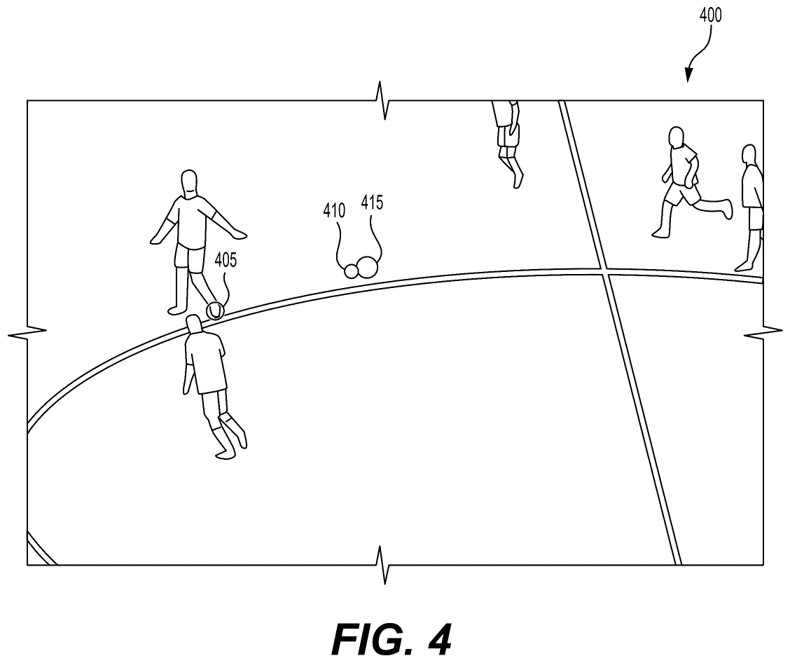

The camera movement in tactical video may be driven by live player tracking data. For example, with reference to FIG. 4, which depicts an image 400 for generating tactical videos, the system environment 100 may utilize an average weighted location 405 that includes the average weighted location of detected players and a ball, and it may further include constraints near the edge of a playing field. A filtered location 410 represents the filtered average weighted location 405, wherein, for example, a low-pass filter has been applied to the average weighted location 405. An animated location 415 represents an animated version of the filtered location 410, wherein animation curves are cased to mimic human-like behavior. Such processing may be based on, for example, computer vision and/or machine learning techniques trained on historical game data, simulated data, team data, sport data, and/or player data. Additionally, for example, a minimum and/or maximum constraint may be applied to the zoom levels (e.g., simulated crop and/or zooming of a video feed) to prevent excessive cropping/zooming. Similarly, for example, additional constraints may ensure a specific number of players are visible in a video feed (e.g., all players are consistently visible; or in an attacking situation, all players in attacking third and defending goalkeeper are visible).

Similarly, for example, tactical video may be based on tracking data that includes team identification data, wherein tactical video may be generated based upon criteria include the currently-defending team and the currently-attacking team, in order to identify a preselected set of players associated with each of these team categories.

Further, machine learning models and prediction models may be trained utilizing tracking data, prior game data, or other historical data to, for example, permit accurate identification and prediction of player and/or team movements, whereupon tactical video generation accurately and efficiently moves with the progression (and predicted progression) of players across a field, resulting in a smooth video appearance. Similarly, existing tracking data (e.g., historical tracking data) as well as live and real-time tracking data may be utilized in connection with machine learning and computer vision techniques to generate tactical video based on predefined tracking data assets, criteria, and attributes.

According to one embodiment, tactical video may be created directly from the video feeds from cameras and/or a broadcast feed, wherein tactical video is generated solely to display the portion of a sports field that satisfies, for example, the tracking data criteria for specific tactical video.

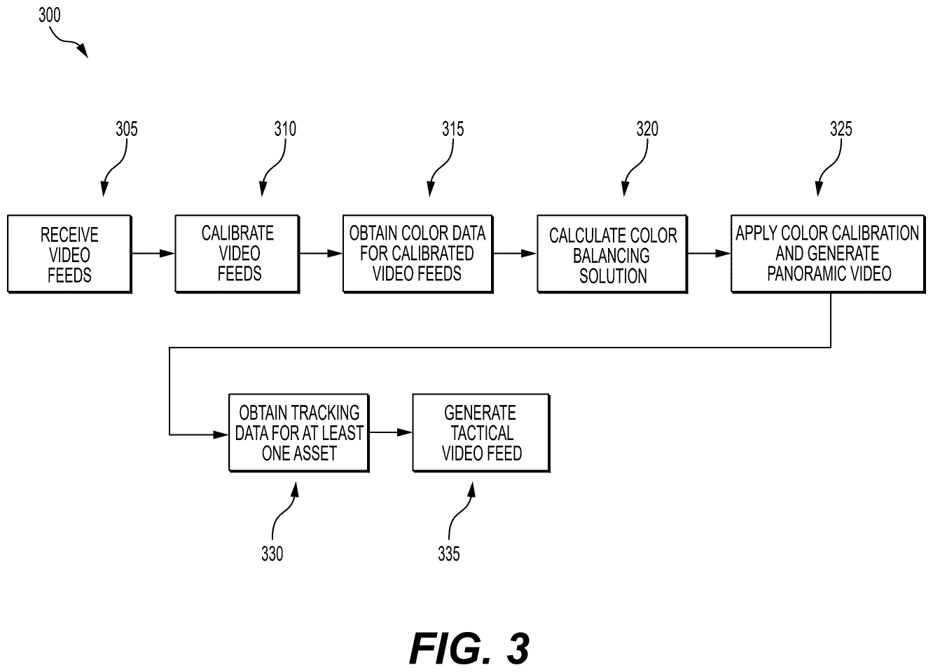

Referring now to FIG. 3, an exemplary flow diagram 300 is shown for generating panoramic video feeds and tactical video feeds, according to example embodiments. As shown in flow diagram 300 of FIG. 3, at step 305, multiple video feeds may be received from cameras 103 located at or within venue 106, and additionally or alternatively, the video feeds may be received from a broadcast feed that is accessed, for example, via a network 105, a local data store, or similar communications means. The video feed may include additional data and/or additional associated data types, including tracking data from tracking system 102 or other data received from the video feed or resulting from preprocessing of the video feed.

At step 310, an automated system and/or a human operator may perform an initial camera/video feed calibration process to identify common points in camera overlap areas as well as to identify landmark points in a playing field, in accordance with techniques discussed herein. For example, computer vision methods may be used to locate playing field landmarks within a video feed and match the landmarks among the different cameras. This calibration process may further include additional settings, including approximate in-venue camera mounting positions and distortion characteristics of particular camera lenses. The calibration steps permit a camera homography to be calculated between each image view (e.g., frame view) and the real-world field position (e.g., field view).

At step 315, color data is obtained for the calibrated video feeds. For example, color data for individual frames from each camera may be periodically obtained for processing. The color data may include a color spectrum or other color metric corresponding to one or more portions of a given calibrated video feed. Alternatively, or in addition, the color data may include an average or otherwise transformed color point corresponding to all or a subset of a given calibrated video feed, wherein statistical values may be computed on a color distribution and the average is one of these statistical values.

At step 320, a color balancing solution is calculated for the multiple video feeds, wherein the system continuously and/or periodically generates color statistics from video frames of each camera and calculates levels of key color metrics to calibrate the colors. These color statistics may be averaged and normalized across each of the cameras to impart color and texture uniformity. For example, this color balancing process may compute statistics of each camera or corresponding feed, such as the mean color and/or deviation of individual colors in an RGB color space. These individual image colors may then be utilized to generate the color average of all images from multiple cameras. Further, the present method may compute this average by utilizing colors only from the sports field (e.g., the surrounding area is excluded) and players on the sports field, and only if players of all teams are present in a specific camera view. This approach permits a high quality video and data output and allows for more accurate processing of extreme cases. The sports field may be automatically identified from the various video feeds in accordance with techniques discussed herein.

For example, statistics may be computed for each camera, so that there are multiple statistics for each camera (e.g., average color, deviation, etc.). According to one embodiment, color statistics from a middle camera (e.g., center camera) are utilized as the target color statistics. The color statistics of the side cameras are then shifted to correspond to the middle camera's color statistics.

According to one embodiment, the color distribution of all cameras may be averaged across the cameras, whereupon all camera color statistics may be shifted to correspond to the average color distribution. Utilizing the average color statistics may, however, introduce quality issues where, for example, all players on a single camera are wearing jerseys of a single color, the average color may be skewed towards this color. To remedy this problem, tracking data may be utilized to recognize when players are visible in an individual camera, wherein the color statistics may be calibrated so that the single camera does not improperly skew the average color. Similarly, tracking data may be utilized to delay computation of the average color statistics until the players are distributed across cameras so as not to skew the color statistics average based on a single camera. Similarly, where lighting conditions vary across the duration of an outdoors sports match (e.g., sunny lighting conditions transition to artificial lighting conditions), there can be quality issues in computing a color statistics average. To remedy this issue, the statistics may be recomputed and/or calibrated at relevant intervals (e.g., an entire match or one or more subsets of a match) so that the color statistics correspond to present lighting conditions and/or when players of both teams are visible on each camera.

Similarly, the camera homography may be utilized to highlight and/or isolate the playing field for calculating color statistics for the playing field and excluding non-playing field areas (e.g., crowd stands, advertisement boards, etc.). For example, the playing field sideline landmarks may be utilized to compute the statistics of a playing field area (e.g., green grass, brown basketball court, etc.), while excluding the advertisement boards, crowd stands, non-active players adjacent/external to the playing field.

At step 325, the color balancing solution is applied to calibrate the video feeds and generate a panoramic video. For example, the color balancing solution may be utilized to alter one or more color properties (e.g., color spectrum, hue, brightness, contrast, tint, exposure, saturation, etc.) in each video feed to reach an average color balance across multiple video feeds. A geometric stitching operation may be applied to the calibrated video feeds to generate a panoramic video feed as disclosed, for example, in step 215.

The color balancing addresses visual corrections, including unbalanced and irregular colors in a video feed as well as different lighting conditions, particularly where individual cameras are positioned to capture different angles of a sports event and are thus located at different locations in a venue.

Machine learning and computer vision models may be trained by utilizing prior game data, prior team data or player data, or other historical data to, for example, permit accurate color identification, balancing, and/or calibration, wherein such historical data may be used to inform different lighting conditions, camera angles, and camera equipment inputs.

It will be appreciated that the color balancing processes may occur prior to the start of a sports event, or they may occur continuously or periodically throughout a sports event.

It will be appreciated that steps 315 and 320 may occur prior to, concurrent with, or following generation of panoramic video where, for example, the color data is obtained from the panoramic video, whereupon the color balancing solution may then be calculated and applied to a generated panoramic video. Similarly, in embodiments that generate a tactical video directly from the received video feeds, the color data may be obtained from the video feeds or from the tactical video, whereupon the color balancing solution may then be calculated and applied to a generated tactical video.

At step 330, tracking data for at least one asset is obtained where such tracking data may include a variety of criteria or attributes for tactical video creation, as described, for example, in step 220. It will be appreciated by one of ordinary skill that step 330 may be performed prior to, concurrent with, or following the generation of panoramic video in step 325.

At step 335, tactical video feeds are generated, wherein the tactical video may include a subset (e.g., zoomed-in and/or cropped “cut-out”) of the panoramic video, generated according to particular parameters for capturing the area of interest, as described elsewhere including, for example, in step 225.

It will be appreciated that in steps 225 and 335 of embodiments disclosed herein, there may be an automated operation configured to apply a pixel blend at the stitching boundary between camera views, introducing a small amount of blur that improves the seamless appearance of the panoramic view. This pixel blend may be tuned to an optimum amount based on computer vision techniques and machine learning techniques trained on historical game data, lighting data, color data, player data, or other datasets informing color balancing. Similarly, a human operator may be available to provide corrections and/or tuning of the pixel blend to make subjective adjustments and, in turn, to provide machine learning feedback on different datasets.

For example, in adjacent camera feeds, the overlap area may be computed between the two adjacent images from adjacent cameras, wherein the overlap area may have a certain width. In the context of, for example, a left camera and a central camera, blending of the adjacent images can be performed such that, for example, at the left edge of the overlap width, the left camera is given a 100% contribution and the central camera is given a 0% contribution. Moving rightwards across the overlap area width, the left camera contribution decreases and the central camera contribution increases. At the midpoint location of the overlap area width, the left camera contribution and the center camera contribution may both be 50%. At the right edge of the overlap width, the left camera is given a 0% contribution and the central camera is given a 100% contribution. It will be appreciated by one of ordinary skill in the art that this context may be applied to additional adjacent cameras (e.g., central camera and right camera). In some instances, the blending area may have a width that creates unpleasant artifacts (e.g., the width may be excessively wide), and the width may be adjusted using computer vision techniques, machine learning techniques, and/or human operator techniques, as discussed previously with respect to correction and/or tuning of video feeds. Similarly, computer vision and/or machine learning techniques may be utilized to compute the optimal image stitching by iteratively testing stitching in real-time to select an optimal stitching setting.

Referring now to FIG. 4, the system environment 100 may utilize an average weighted location 405 that includes the average weighted location of detected players and a ball, and it may further include constraints near the edge of a playing field. A filtered location 410 represents the filtered average weighted location 405, wherein, for example, a low-pass filter has been applied to the average weighted location 405. An animated location 415 represents an animated version of the filtered location 410, wherein animation curves are cased to mimic human-like behavior. Such processing may be based on, for example, computer vision and/or machine learning techniques trained on historical game data, team data, sport data, and/or player data. The average weighted location 405, filtered location 410, and animated location 415 may be utilized to create delays in speeding up/slowing down movement of the center view of the tactical camera. For example, these methods may be utilized to mimic the camera movement of a television broadcast where, for example, a human camera operator may be delayed in trailing the movement of an object (e.g., ball, player, etc.) when the object changes direction, stops moving, etc.

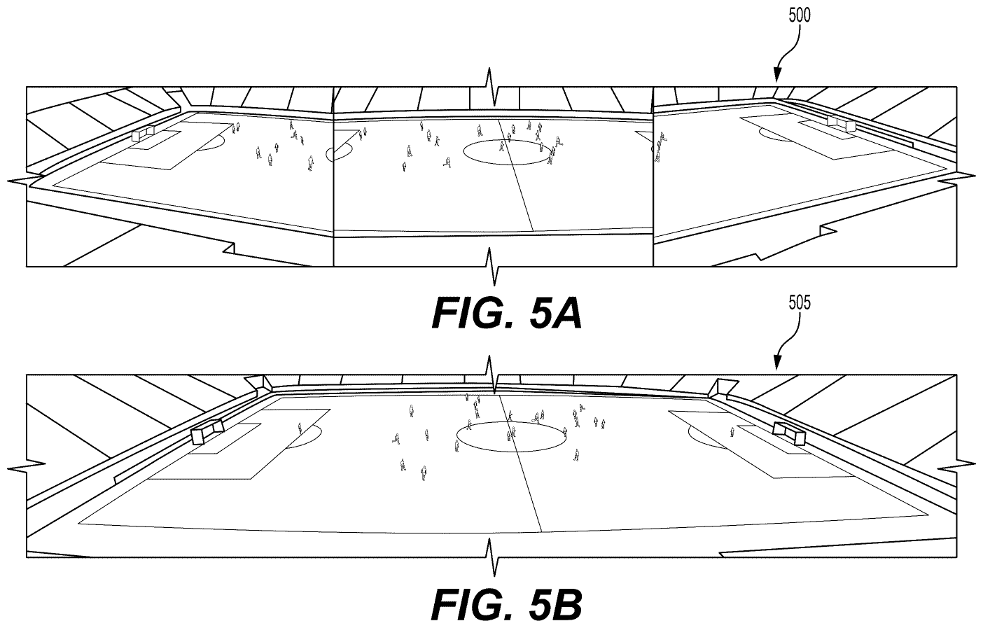

Referring now to FIG. 5A, an exemplary representation 500 is shown for an unstitched view of three different camera feeds. FIG. 5B depicts an exemplary representation 505 of a still frame from a panoramic video generated according to the present embodiments, wherein the different camera feeds have been calibrated to display a single, calibrated view of the entirety of a playing field including the color calibration discussed in reference to FIG. 3.

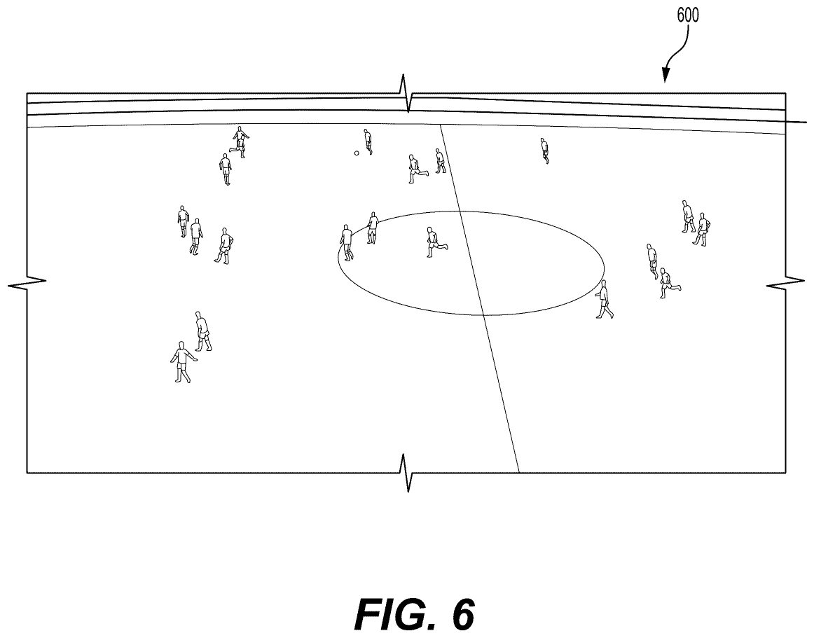

Referring now to FIG. 6, an exemplary representation 600 is shown for a still frame from a tactical video generated from a panoramic video, according to the present embodiments. This tactical video of representation 600 may be a subset of the panoramic video of FIG. 5B. The visual data depicted via the tactical video of representation 600 may be determined in accordance with one or more viewing parameters, as discussed herein.

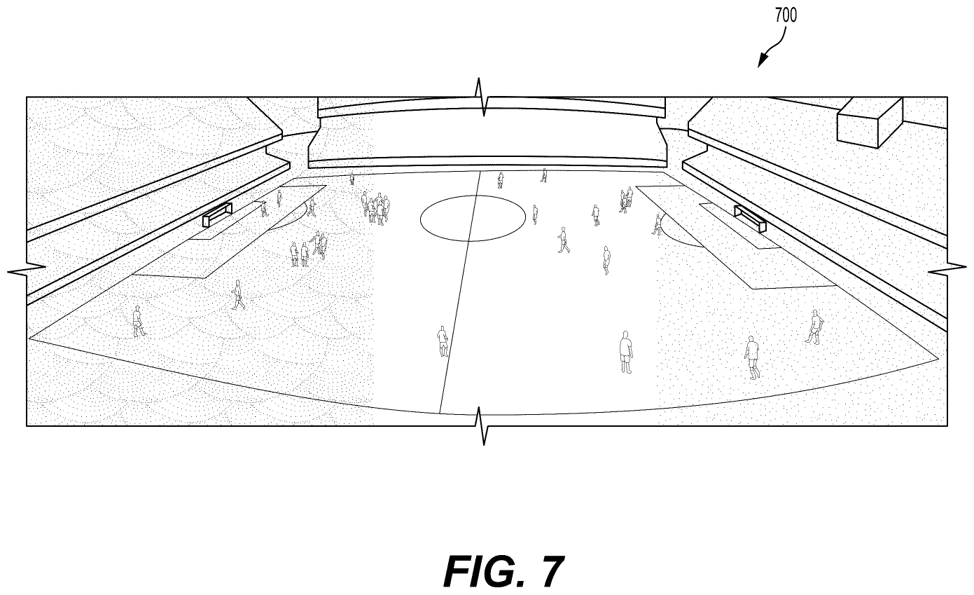

Referring now to FIG. 7, an exemplary representation 700 is shown for a still frame from a panoramic video in which color balancing and/or calibration has not yet been performed, resulting in different color levels, exposures, and hues across the different camera feeds stitched together.

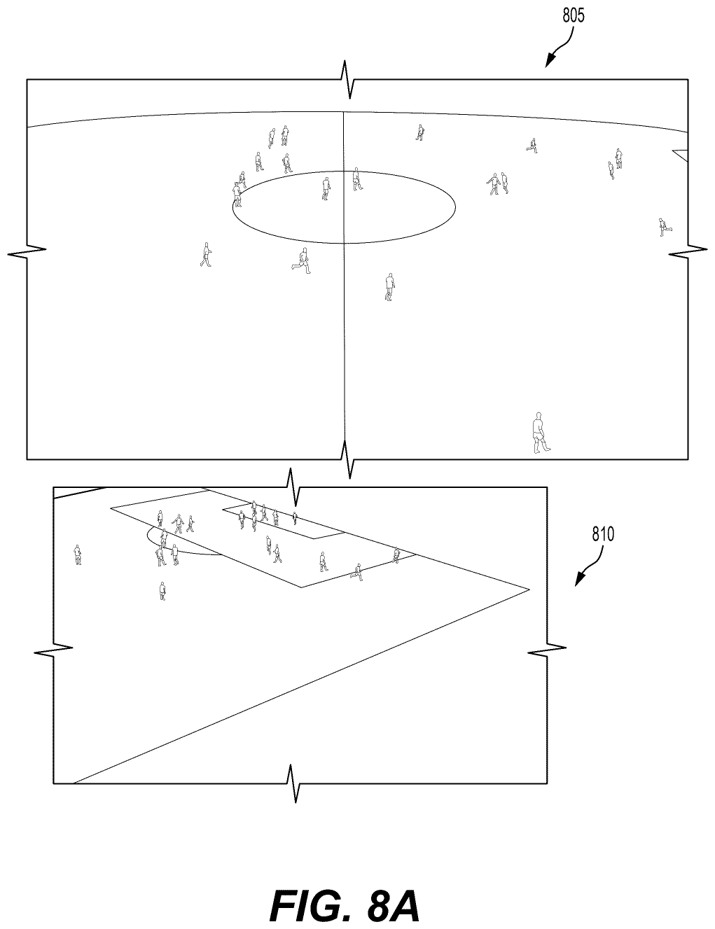

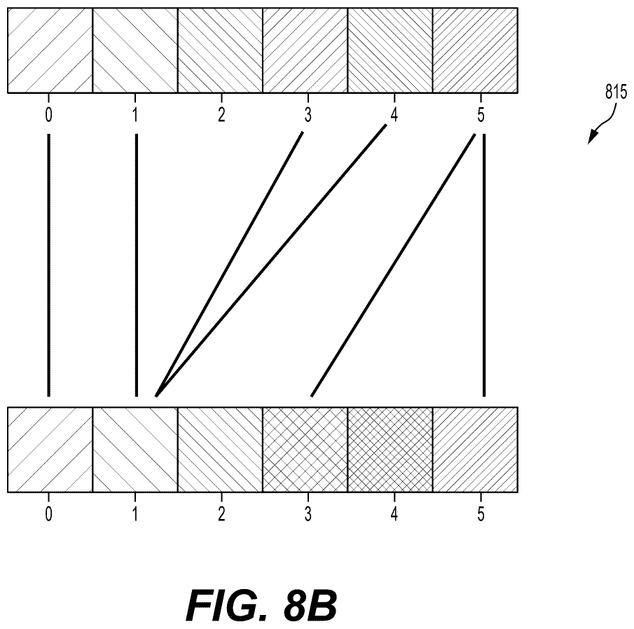

Referring now to FIG. 8A, an exemplary representation of cropped/extracted video feed frames are shown for color balancing, according to example embodiments. For example, video feed frames 805 and 810 are utilized for extracting the most prominent colors, wherein the playing field has been cropped/extracted from the video frame, permitting a more accurate color balancing and color matching process, wherein extraneous color data (e.g., colors from the sidelines, grandstand, etc.) may be excluded from the analysis.

Referring now to FIG. 8B, an exemplary representation is shown for color balancing, according to example embodiments. For example, a pair-wise matching process 815 is performed on the video frames of FIG. 8A, where the most prominent colors are matched to each other, whereupon the matched colors may be applied to the video feed (e.g., panoramic video and/or tactical video) to balance the colors across stitched-together video feeds. For example, the color balancing depicted in FIG. 8B may use a pre-processing step that groups similar colors together for an image in five groups. Statistics are then computed for all images for each group using the methods described, for example, with respect to FIG. 3. The most similar colors are then matched together between images and color balancing is performed as described elsewhere herein, as for example, with respect to FIG. 3.

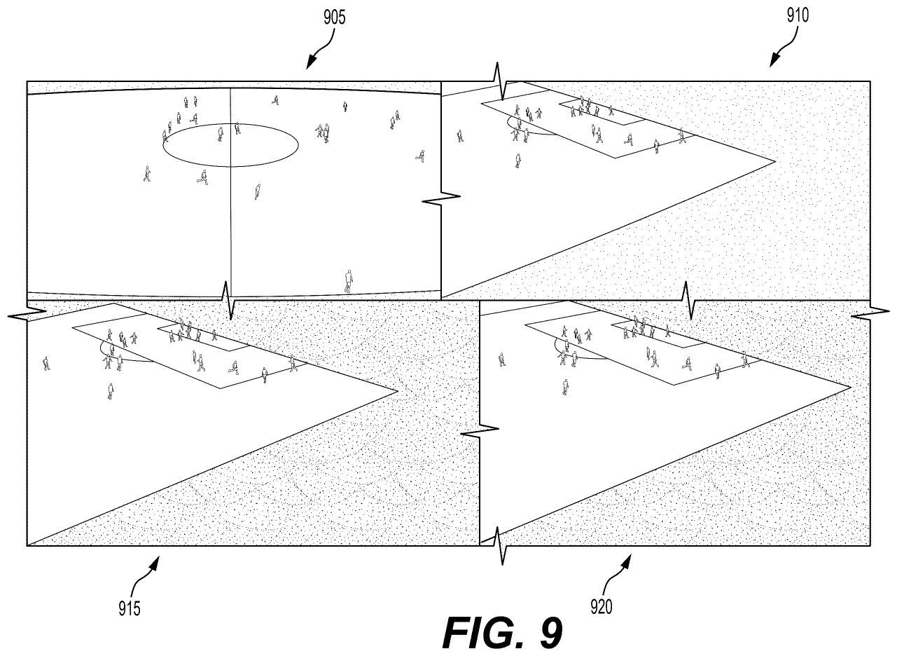

Referring now to FIG. 9, an exemplary representation is shown for the cropping/extraction of the playing field from video frames 905, 910, 915, and 920. For example, as part of the processing steps of FIGS. 2-3, video frames may be cropped so that the area surrounding the playing field (e.g., sidelines, crowd seating areas, etc.) are removed from the video frame. The cropping process isolates the playing field portion of the video frame, thus facilitating calibration and/or further processing of the video feeds. It will be appreciated by one of ordinary skill that this cropping step may occur, for example, at steps 210 and/or 310, or may occur at one or more steps in the methods of FIG. 2-3. At video frame 905, a video feed is shown from a camera positioned at midfield and positioned to capture the middle of a playing field, wherein the video frame 905 has been cropped to isolate the playing field. Similarly, at video frames 910, 915, and 920, a video feed is shown from a camera positioned to capture an end of a playing field, wherein the video frames 910, 915, and 920 have been cropped to isolate the playing field.

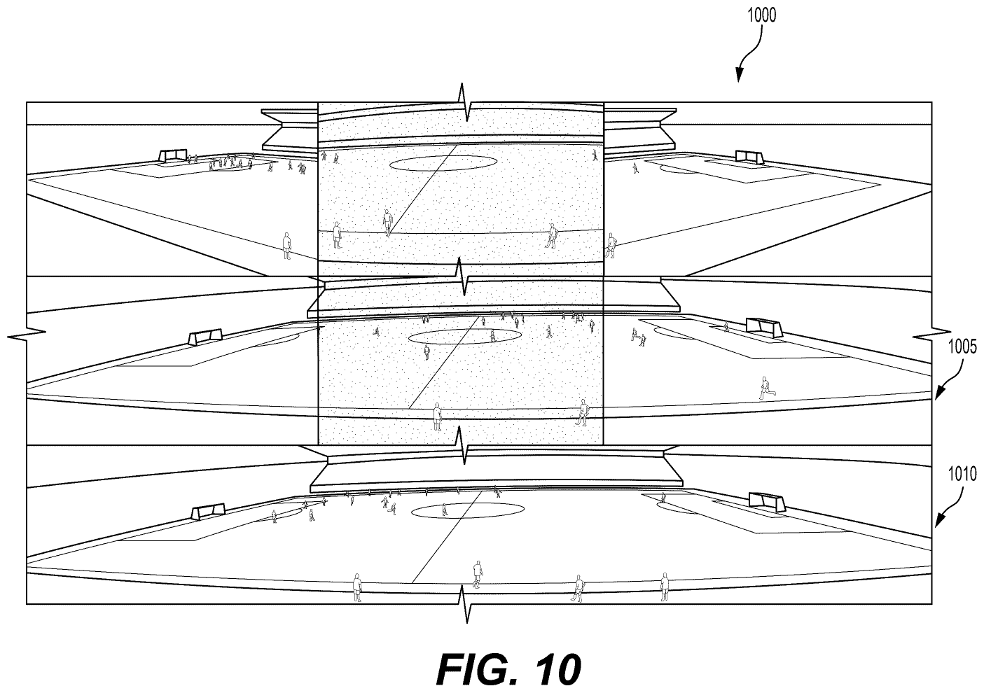

Referring now to FIG. 10, exemplary representations are shown for multiple video feeds 1000, 1005, and 1010, according to example embodiments. In video feed 1000, individual video feeds from three individual cameras are provided, wherein the individual feeds have not been stitched together, calibrated, or color balanced. In video feed 1005, the individual video feeds from video feed 1000 are stitched together and calibrated according to methods described herein, wherein a single, calibrated video feed is generated that has not been color balanced. In video feed 1010, the single calibrated video feed 1005 is color balanced according to methods described herein, wherein a single stitched together, calibrated, and color balanced video feed is generated.

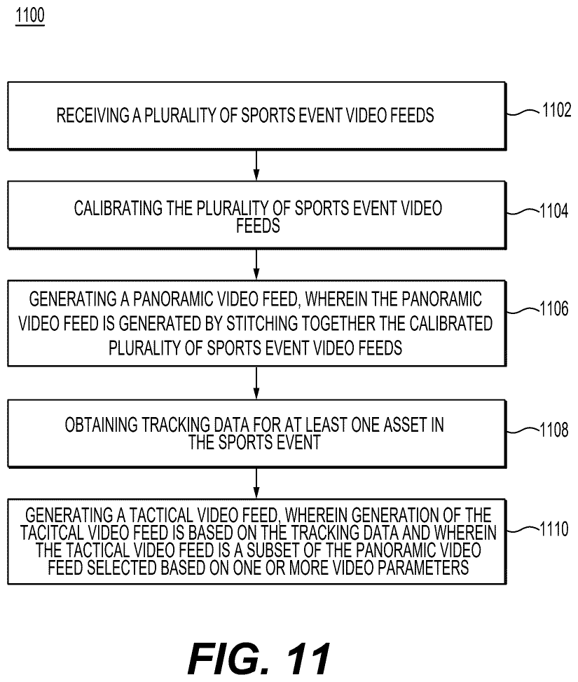

FIG. 11 depicts a flow diagram of a method 1100 for video generation in a sports event, according to example embodiments. In some aspects, the method 1100 may be performed by the computing system 104.

As shown in FIG. 11, the method 1100 may include receiving, via a computer (e.g., the computing system 104), a plurality of sports event video feeds (1102). The method 1100 may include calibrating, via the computer, the plurality of sports event video feeds (1104). In some embodiments, calibrating, the plurality of sports event video feeds may further comprise (i) identifying, via the computer, common points between the plurality of sports event video feeds, and (ii) calculating, via the computer, a camera homography between each of the plurality of sports events feeds, wherein the camera homography is based on the identified common points.

The method 1100 may include generating, via the computer, a panoramic video feed, wherein the panoramic video feed is generated by stitching together the calibrated plurality of sports event video feeds (1106). In some embodiments, generating the panoramic video feed may further comprise (i) obtaining, via the computer, color data for each of the calibrated plurality of sports event video feeds, (ii) calculating, via the computer, a color balancing solution based on the color data for each of the calibrated plurality of sports event video feeds, and (iii) applying, via the computer, a color calibration to the panoramic video feed, wherein the color calibration is based on the color balancing solution. The color data may be obtained, via the computer, prior to the start of the sports event. In some embodiments, calculating the color balancing solution may further comprise (i) extracting, via the computer, at least one prominent color from at least one of the calibrated plurality of sports event video feeds, (ii) matching, via the computer, the at least one prominent color to at least one prominent color from a different calibrated sports event video feed to generate at least one matched color pair, and (iii) incorporating, via the computer, the at least one matched color pair into the color data.

The method 1100 may include obtaining, via the computer, tracking data for at least one asset in the sports event (1108). In some embodiments, the tracking data may comprise tracking data for at least one player in the sports event. The method 1100 may include generating, via the computer, a tactical video feed, wherein generation of the tactical video feed is based on the tracking data and wherein the tactical video feed is a subset of the panoramic video feed selected based on one or more video parameters (1110). In some embodiments, the tactical video feed may be dynamically updated, via the computer, based on updates to the tracking data.

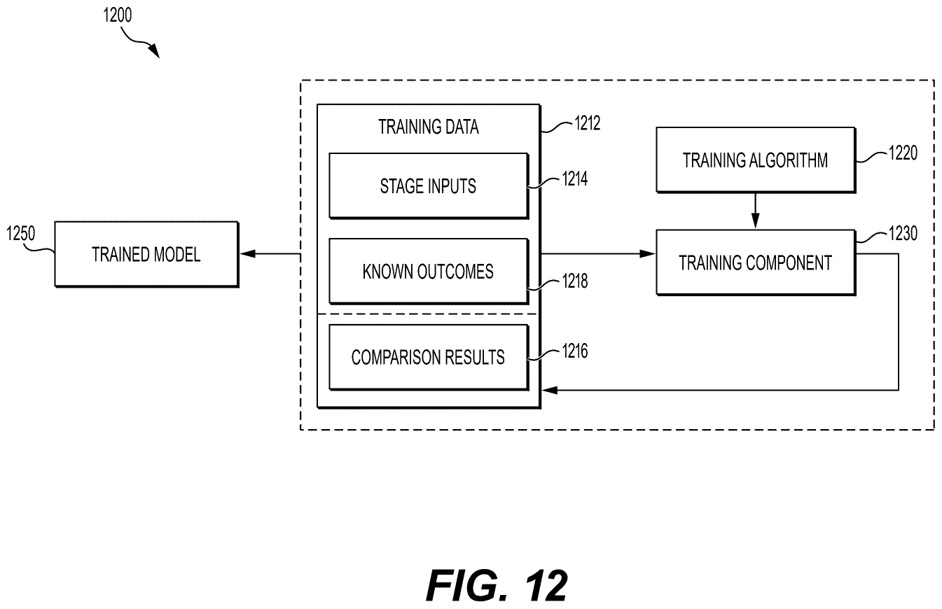

FIG. 12 depicts a flow diagram for training a machine learning model, according to example embodiments. As shown in flow diagram 1210 of FIG. 12, training data 1212 may include one or more of stage inputs 1214 and known outcomes 1218 related to a machine learning model to be trained. The stage inputs 1214 may be from any applicable source including a component or set shown in the figures provided herein. The known outcomes 1218 may be included for machine learning models generated based on supervised or semi-supervised training. An unsupervised machine learning model might not be trained using known outcomes 1218. Known outcomes 1218 may include known or desired outputs for future inputs similar to or in the same category as stage inputs 1214 that do not have corresponding known outputs.

The training data 1212 and a training algorithm 1220 may be provided to a training component 1230 that may apply the training data 1212 to the training algorithm 1220 to generate a trained machine learning model 1250. According to an implementation, the training component 1230 may be provided comparison results 1216 that compare a previous output of the corresponding machine learning model to apply the previous result to re-train the machine learning model. The comparison results 1216 may be used by the training component 1230 to update the corresponding machine learning model. The training algorithm 1220 may utilize machine learning networks and/or models including, but not limited to, a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flowchart 1200 may be a trained machine learning model 1250.

It will be appreciated that training of a machine learning may incorporate, partially or wholly, elements illustrated in FIGS. 2-11, discussed above.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

FIG. 13A illustrates an architecture of computing system 1300, according to example embodiments. The computing system 1300 may also be referred to herein as “system 1300.” System 1300 may be representative of at least a portion of computing system 104. One or more components of system 1300 may be in electrical communication with each other using a bus 1305. System 1300 may include a processing unit (CPU or processor) 1310 and a system bus 1305 that couples various system components including the system memory 1315, such as read only memory (ROM) 1320 and random access memory (RAM) 1325, to processor 1310. System 1300 may include a cache of high-speed memory connected directly with, in close proximity to, or integrated as part of processor 1310. System 1300 may copy data from memory 1315 and/or storage device 1330 to cache 1312 for quick access by processor 1310. In this way, cache 1312 may provide a performance boost that avoids processor 1310 delays while waiting for data. These and other modules may control or be configured to control processor 1310 to perform various actions. Other system memory 1315 may be available for use as well. Memory 1315 may include multiple different types of memory with different performance characteristics. Processor 1310 may include any general purpose processor and a hardware module or software module, such as service 1 1332, service 2 1334, and service 3 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction with the computing system 1300, an input device 1345 may represent any number of input mechanisms, such as a microphone for speech, a touch-sensitive screen for gesture or graphical input, keyboard, mouse, motion input, speech and so forth. An output device 1335 (e.g., display) may also be one or more of a number of output mechanisms known to those of skill in the art. In some instances, multimodal systems may enable a user to provide multiple types of input to communicate with computing system 1300. Communications interface 1340 may generally govern and manage the user input and system output. There is no restriction on operating on any particular hardware arrangement and therefore the basic features here may easily be substituted for improved hardware or firmware arrangements as they are developed.

Storage device 1330 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1325, read only memory (ROM) 1320, and hybrids thereof.

Storage device 1330 may include services 1332, 1334, and 1336 for controlling the processor 1310. Other hardware or software modules are contemplated. Storage device 1330 may be connected to system bus 1305. In one aspect, a hardware module that performs a particular function may include the software component stored in a computer-readable medium in connection with the necessary hardware components, such as processor 1310, bus 1305, output device 1335, and so forth, to carry out the function.

FIG. 13B illustrates a computer system 1350 having a chipset architecture that may represent at least a portion of computing system 104. Computer system 1350 may be an example of computer hardware, software, and firmware that may be used to implement the disclosed technology. System 1350 may include a processor 1355, representative of any number of physically and/or logically distinct resources capable of executing software, firmware, and hardware configured to perform identified computations. Processor 1355 may communicate with a chipset 1360 that may control input to and output from processor 1355. In this example, chipset 1360 outputs information to output 1365, such as a display, and may read and write information to storage device 1370, which may include magnetic media, and solid-state media, for example. Chipset 1360 may also read data from and write data to RAM 1375. A bridge 1380 for interfacing with a variety of user interface components 1385 may be provided for interfacing with chipset 1360. Such user interface components 1385 may include a keyboard, a microphone, touch detection and processing circuitry, a pointing device, such as a mouse, and so on. In general, inputs to system 1350 may come from any of a variety of sources, machine generated and/or human generated.

Chipset 1360 may also interface with one or more communication interfaces 1390 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 1355 analyzing data stored in storage device 1370 or RAM 1375. Further, the machine may receive inputs from a user through user interface components 1385 and execute appropriate functions, such as browsing functions by interpreting these inputs using processor 1355.

It may be appreciated that example systems 1300 and 1350 may have more than one processor 1310 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method for video generation in a sports event, the method comprising:
receiving, via a computer, a plurality of sports event video feeds;
calibrating, via the computer, the plurality of sports event video feeds;
generating, via the computer, a panoramic video feed, wherein the panoramic video feed is generated by stitching together the calibrated plurality of sports event video feeds;
obtaining, via the computer, tracking data for at least one asset in the sports event; and
generating, via the computer, a tactical video feed, wherein generation of the tactical video feed is based on the tracking data and wherein the tactical video feed is a subset of the panoramic video feed selected based on one or more video parameters.

2. The method of claim 1, wherein the tracking data comprises tracking data for at least one player in the sports event.

3. The method of claim 1, wherein calibrating the plurality of sports event video feeds further comprises:
identifying, via the computer, common points between the plurality of sports event video feeds; and
calculating, via the computer, a camera homography between each of the plurality of sports events feeds, wherein the camera homography is based on the identified common points.

4. The method of claim 1, wherein the tactical video feed is dynamically updated, via the computer, based on updates to the tracking data.

5. The method of claim 1, wherein generating a panoramic video feed further comprises:
obtaining, via the computer, color data for each of the calibrated plurality of sports event video feeds;
calculating, via the computer, a color balancing solution based on the color data for each of the calibrated plurality of sports event video feeds; and
applying, via the computer, a color calibration to the panoramic video feed, wherein the color calibration is based on the color balancing solution.

6. The method of claim 5, wherein the color data is obtained, via the computer, prior to the start of the sports event.

7. The method of claim 5, wherein calculating a color balancing solution further comprises:
extracting, via the computer, at least one prominent color from at least one of the calibrated plurality of sports event video feeds;
matching, via the computer, the at least one prominent color to at least one prominent color from a different calibrated sports event video feed to generate at least one matched color pair; and
incorporating, via the computer, the at least one matched color pair into the color data.

8. A system for video generation in a sports event, the system comprising:
a non-transitory computer readable medium configured to store processor-readable instructions; and
a processor operatively connected to the non-transitory computer readable medium, and configured to execute the instructions to perform operations comprising:
receiving a plurality of sports event video feeds;
calibrating the plurality of sports event video feeds;
generating a panoramic video feed, wherein the panoramic video feed is generated by stitching together the calibrated plurality of sports event video feeds;
obtaining tracking data for at least one asset in the sports event; and
generating a tactical video feed, wherein generation of the tactical video feed is based on the tracking data and wherein the tactical video feed is a subset of the panoramic video feed selected based on one or more video parameters.

9. The system of claim 8, wherein the tracking data comprises tracking data for at least one player in the sports event.

10. The system of claim 8, wherein calibrating the plurality of sports event video feeds further comprises:
identifying common points between the plurality of sports event video feeds; and
calculating a camera homography between each of the plurality of sports events feeds, wherein the camera homography is based on the identified common points.

11. The system of claim 8, wherein the tactical video feed is dynamically updated, via the computer, based on updates to the tracking data.

12. The system of claim 8, wherein generating a panoramic video feed further comprises:
obtaining color data for each of the calibrated plurality of sports event video feeds;
calculating a color balancing solution based on the color data for each of the calibrated plurality of sports event video feeds; and
applying a color calibration to the panoramic video feed, wherein the color calibration is based on the color balancing solution.

13. The system of claim 12, wherein the color data is obtained, via the computer, prior to the start of the sports event.

14. The system of claim 12, wherein calculating a color balancing solution further comprises:
extracting at least one prominent color from at least one of the calibrated plurality of sports event video feeds;
matching the at least one prominent color to at least one prominent color from a different calibrated sports event video feed to generate at least one matched color pair; and
incorporating the at least one matched color pair into the color data.

15. A non-transitory computer readable medium configured to store processor-readable instructions, wherein when executed by a processor, the instructions perform operations comprising:
receiving a plurality of sports event video feeds;
calibrating the plurality of sports event video feeds;
generating a panoramic video feed, wherein the panoramic video feed is generated by stitching together the calibrated plurality of sports event video feeds;
obtaining tracking data for at least one asset in the sports event; and
generating a tactical video feed, wherein generation of the tactical video feed is based on the tracking data and wherein the tactical video feed is a subset of the panoramic video feed selected based on one or more video parameters.

16. The non-transitory computer readable medium of claim 15, wherein the tracking data comprises tracking data for at least one player in the sports event.

17. The non-transitory computer readable medium of claim 15, wherein calibrating the plurality of sports event video feeds further comprises:
identifying common points between the plurality of sports event video feeds; and
calculating a camera homography between each of the plurality of sports events feeds, wherein the camera homography is based on the identified common points.

18. The non-transitory computer readable medium of claim 15, wherein the tactical video feed is dynamically updated, via the computer, based on updates to the tracking data.

19. The non-transitory computer readable medium of claim 15, wherein generating a panoramic video feed further comprises:
obtaining color data for each of the calibrated plurality of sports event video feeds;
calculating a color balancing solution based on the color data for each of the calibrated plurality of sports event video feeds; and
applying a color calibration to the panoramic video feed, wherein the color calibration is based on the color balancing solution.

20. The non-transitory computer readable medium of claim 19, wherein calculating a color balancing solution further comprises:
extracting at least one prominent color from at least one of the calibrated plurality of sports event video feeds;
matching the at least one prominent color to at least one prominent color from a different calibrated sports event video feed to generate at least one matched color pair; and
incorporating the at least one matched color pair into the color data.
